(19) United States
(12) Patent Application Publication
(10) Pub. No.: US 2024/0391033 A1
(43) Pub. Date: Nov. 28, 2024

(54) WELDING METHOD FOR IMPROVING QUALITY OF 5G ALL-POSITION WELDING OF MARINE RISER AND PRODUCT THEREOF

(71) Applicant: Tianjin University, Tianjin (CN)

(72) Inventors: Lianyong Xu, Tianjin (CN); Kangda Hao, Tianjin (CN); Yongdian Han, Tianjin (CN); Lei Zhao, Tianjin (CN); Wenjing Ren, Tianjin (CN); Hongyang Jing, Tianjin (CN)

(73) Assignee: Tianjin University, Tianjin (CN)

(21) Appl. No.: 18/671,966

(22) Filed: May 22, 2024

(30) Foreign Application Priority Data
May 25, 2023 (CN) 202310603625.6

(51) Int. Cl. B23K 31/02; B23K 37/00

(52) U.S. Cl. CPC B23K 31/02; B23K 37/00

(57) ABSTRACT

A welding method for improving quality of 5G all-position welding of a marine riser and a product thereof are provided, and the disclosure belongs to the technical field of welding. The welding method specifically includes the following. welding the marine riser in 5G all positions using a unified welding mode; reducing a predetermined voltage or reducing predetermined inductance in an overhead welding position to improve directivity and stability of an arc; and meanwhile increasing an arc swing width in the overhead welding position to eliminate a lack-of-fusion defect. In the disclosure, a unified welding mode suitable for flat welding is applied to marine riser welding. The process of 5G all-position welding of the marine riser is effectively simplified. The welding quality of 5G all-position welding of the marine riser is thereby effectively improved.

### CROSS-REFERENCE TO RELATED APPLICATION

This application claims the priority benefit of China application serial no. 202310603625.6, filed on May 25, 2023. The entirety of the above-mentioned patent application is hereby incorporated by reference herein and made a part of this specification.

### BACKGROUND

### Technical Field

The disclosure belongs to the technical field of welding, and more specifically, relates to a welding method for improving quality of 5G all-position welding of a marine riser and a product thereof.

### Description of Related Art

Since their first application on tension leg platforms in the Gulf of Mexico in 1994, steel catenary risers have gained popularity in deepwater development due to advantages such as strong high temperature and high pressure resistance, relatively simple manufacturing process, and low costs. As the water depth increases and the length of the riser increases, the marine environment becomes more severe. The vortex-induced oscillation generated underwater will cause severe vibrations perpendicular to the direction of the water flow and the axis of the cylinder. Further, when steel catenary risers are connected to the platform through joints, the effect of alternating loads will also be doubled. Risers that have been in this state for a long time will have their service life shortened due to frequent operation, resulting in fatigue damage at the welded joints. Therefore, high welding joint quality is a prerequisite for the safe service of marine risers.

At present, the fully automatic welding systems equipped on the operation lines of China's major pipe-laying vessels HYSY201, HYSY202, and Lanjiang are all Sturnax 05 systems manufactured by SERIMAX. The core welding technology has been kept secret, so the manufacturer's welding technology support thus become critical. Under the current 5G all-position welding conditions of marine risers, arc instability in the overhead welding state can easily lead to the lack-of-fusion defect, so the improvement of the quality of marine riser joints is thus considerably limited.

### SUMMARY

In view of the defects found in the related art, the disclosure aims to provide a welding method for improving quality of 5G all-position welding of a marine riser, so as to solve the problem of easy generation of the lack-of-fusion defect caused by arc instability in the overhead welding state found in the existing welding technology.

To achieve the above, the disclosure provides a welding method for improving quality of 5G all-position welding of a marine riser. The welding method specifically includes the following. The marine riser is welded in 5G all positions using a unified welding mode. A predetermined voltage is reduced or predetermined inductance is reduced in an overhead welding position to improve directivity and stability of an arc. Meanwhile, an arc swing width is increased in the overhead welding position to eliminate a lack-of-fusion defect.

Further preferably, the overhead welding position is where an overhead welding angle is 120° to 180°.

Further preferably, a voltage is lowered by 0.5 V to 2 V to reduce an arc length.

Further preferably, inductance is reduced by 0.5 H to 1 H to increase arc stiffness.

Further preferably, an arc swing width is increased by 0.2 mm to 0.6 mm in the overhead welding position to eliminate the lack-of-fusion defect.

Further preferably, a robot or a rail car is adopted to achieve fully automatic welding.

Further preferably, a size of the marine riser ranges from 6 inches to 18 inches.

Further preferably, a wall thickness of the marine riser is 19 mm to 32 mm.

Further preferably, a groove form of the marine riser is U-shaped.

According to another aspect of the disclosure, a marine riser prepared by the above method is provided.

To sum up, the above technical solutions provided by the disclosure have the following beneficial effects compared with the related art.
1. In the disclosure, a unified welding mode suitable for flat welding is creatively applied to marine riser welding. In this way, there is no need to carry out complicated matching of current, voltage, and wire feeding speed, and the process of 5G all-position welding of the marine riser is effectively simplified. Further, considering the problem of poor stability when the marine riser is welded through the unified welding mode, in the disclosure, in the overhead welding position, on the one hand, the arc stability is improved by reducing the voltage or inductance, and on the other hand, the lack-of-fusion defect is effectively eliminated by increasing the arc swing width. The welding quality of 5G all-position welding of the marine riser is thereby effectively improved.
2. In particular, considering that the molten pool shape is uncontrollable due to the gravity of the liquid molten pool, arc instability and the lack-of-fusion defect are prone to occur at the overhead welding angle of 120° to 180°. Therefore, in the disclosure, the specific angle of the overhead welding position is optimized. In this way, the welding quality and welding efficiency of 5G all-position welding of the marine riser are further improved.
3. Moreover, in the disclosure, the reduced voltage and inductance and the increased arc swing width are optimized, so that the lack-of-fusion defect is prevented from being generated and the welding safety is ensured.

### BRIEF DESCRIPTION OF THE DRAWINGS

FIG. 1 is an RT image of marine riser welding provided by Example 1 of the disclosure.

FIG. 2 is an RT image of marine riser welding provided by Example 2 of the disclosure.

FIG. 3 is a physical image of marine riser welding provided by Comparative Example 1 of the disclosure.

### DESCRIPTION OF THE EMBODIMENTS

In order to make the objectives, technical solutions, and advantages of the disclosure clearer and more comprehensible, the disclosure is further described in detail with reference to the drawings and embodiments. It should be understood that the specific embodiments described herein serve to explain the disclosure merely and are not used to limit the disclosure.

According to one aspect of the disclosure, a welding method for improving welding quality of a marine riser in 5G all positions is provided. The welding method specifically includes the following. The marine riser is welded in 5G all positions through a unified welding mode. Considering that under the unified welding mode, for multi-layer single-pass welding of a U-shaped groove of the marine riser, a molten pool shape in an overhead welding position is uncontrollable due to gravity of a liquid molten pool, so a lack-of-fusion defect may easily occur. Therefore, on the one hand, directivity and stability of an arc may be improved by reducing a predetermined voltage or reducing predetermined inductance in an overhead welding position. On the other hand, lateral diffusion of liquid metal may be promoted by increasing an arc swing width in the overhead welding position to eliminate the lack-of-fusion defect.

Further, the position where arc instability and the lack-of-fusion defect are prone to occur is at the 120° to 180° angle of an overhead welding angle, that is, position from 4 o'clock to 6 o'clock. In the above overhead welding position, the molten pool shape is uncontrollable due to the gravity of the liquid molten pool, and the lack-of-fusion defect is prone to occur. Therefore, by correcting the voltage or inductance at this position and meanwhile increasing the arc swing width, a high-quality marine riser joint exhibiting a stable welding process without lack-of-fusion defect may be obtained.

Further, since the molten pool is affected by a series of complex forces such as gravity, surface tension, and arc blowing force, the arc exhibits different weldability at different welding positions. Herein, surface tension and arc blowing force are forces that hinder the downward flow of the molten pool and are able to support the molten pool, and the arc blowing force, in particular, can cause molten pool metal to flow laterally from the center to both sides. However, when the arc is in the overhead welding position, gravity has the greatest influence on formation of a welded seam. At this time, a speed of the molten pool metal flowing downward is accelerated, especially when the molten pool metal flows to the front of the arc, the arc is disturbed and it stability is thus reduced.

An arc voltage is an important parameter affecting the stability of the welding process. Reducing the arc voltage in the overhead welding position can shorten an arc length, and when a droplet forms a smaller size, a short-circuit transition occurs with the molten pool. In this way, arc drift may be avoided, and arc stability is thereby ensured. On the other hand, inductance is also one of the important factors affecting arc stability. Reducing the inductance in the overhead welding position can increase the frequency of droplet short-circuit transition, so arc stiffness is improved and generation of large particle splash when the arc drifts is suppressed. Whether the arc voltage or inductance is reduced, the arc thrust may be enhanced, so that the lateral flow speed of the molten pool metal increases. Coupled with a fast arc swing speed, the lack-of-fusion defect can be effectively eliminated.

However, excessively low arc voltage causes the welded seam to appear in a narrow arch shape and induce lack of fusion. If the inductance is excessively low, the short-circuit current increases excessively fast, and the droplet may easily explode during the transition. An excessive arc swing width can easily cause side wall arcing when a contact tip contacts a side wall, resulting in undercutting on an upper wall. Therefore, in the disclosure, for the overhead welding position, the optimized voltage correction is reduced by 0.5V to 2V, the optimized inductance correction is reduced by 0.5H to 1H, and the optimized swing width is increased by 0.2 mm to 0.6 mm compared with other positions. In this way, arc stability may be effectively improved and the lack-of-fusion defect may be eliminated.

Further, a robot or a rail car is adopted to achieve fully automatic welding.

Further, a size of the marine riser ranges from 6 inches to 18 inches, a wall thickness of the marine riser is 19 mm to 32 mm, and a groove form of the marine riser is U-shaped.

According to another aspect of the disclosure, a marine riser prepared by the above method is provided. The marine riser has no lack-of-fusion defect and exhibits high quality.

The technical solutions provided by the disclosure are further described in detail according to the following specific examples.

### Example 1

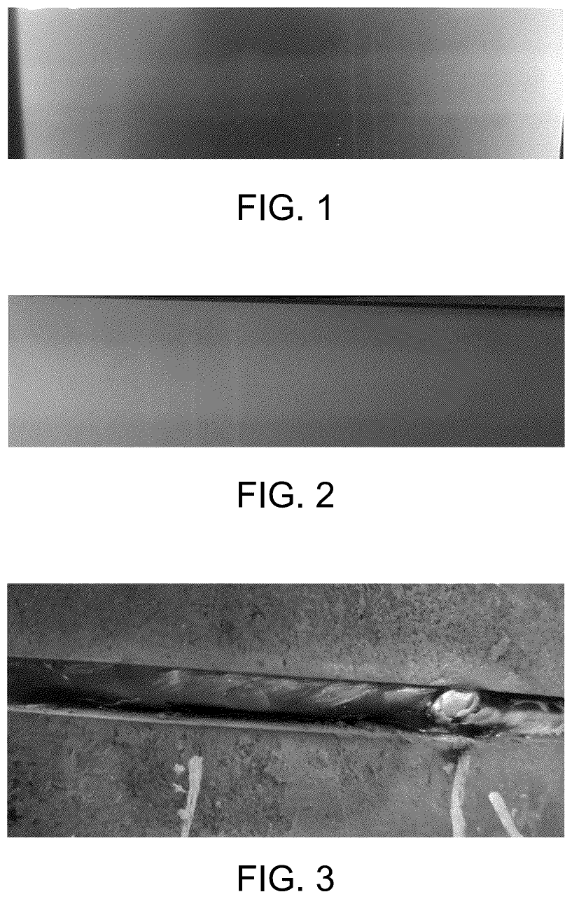

In this example, the material to be welded is a marine riser with a size of 12 inches and a material of X65, and the welding processes used in this example are CMT (cold metal transfer) back welding+GMAW (gas metal arc welding) filler welding. In the filler welding, the wire feeding speed is 9.5 m/min and the welding speed is 470 mm/min for 0° to 120°, and the wire feeding speed is 8.5 m/min and the welding speed is 430 mm/min for 120° to 180°. In the filler layer, the arc voltage is reduced by 1.5V through voltage correction at 120° to 180°, or the inductance is reduced by 0.8H through inductance correction. During the welding process, the arc stability is enhanced, the phenomenon that the arc is attracted to the side wall disappears, and formation of a weld tends to be normal. However, the RT results show that intermittent lack-of-fusion defects exist between 120° and 180°, as shown in FIG. 1.

### Example 2

The material to be welded in this example is consistent with that in Example 1, and the welding parameters such as the wire feeding speed, welding speed, voltage correction, or inductance correction at different positions are also consistent with that in Example 1. The difference is that the arc swing width of the filler layer at 120° to 180° increases by 0.4 mm compared with 0° to 120°. During the welding process, the arc is stable, the weld is formed in a favorable manner, and the lack-of-fusion defect does not occur in RT inspection, as shown in FIG. 2.

### Comparative Example 1

In this example, the material to be welded is a marine riser with a size of 12 inches and a material of X65, and the welding processes used in this example are CMT back welding+GMAW filler welding. In the filler welding, the wire feeding speed is 9.5 m/min and the welding speed is 470 mm/min for 0° to 120°, and the wire feeding speed is 8.5 m/min and the welding speed is 430 mm/min for 120° to 180°. The voltage and inductance are set according to the unified mode without correction, and the arc swing width in each filler layer remains consistent between 0° and 120° and 120° and 180°.

When the welding reaches 120°, the welding arc begins to diverge and drift, and the arc directivity is poor. Especially when the welding reaches 165° to 180°, the arc is easily attracted to the side wall and the weld is also biased to one side, as shown in FIG. 3.

A person having ordinary skill in the art should be able to easily understand that the above description is only preferred embodiments of the disclosure and is not intended to limit the disclosure. Any modifications, equivalent replacements, and modifications made without departing from the spirit and principles of the disclosure should fall within the protection scope of the disclosure.

What is claimed is:

1. A welding method for improving quality of 5G all-position welding of a marine riser, specifically comprising: welding the marine riser in 5G all positions using a unified welding mode; in view of problems of an uncontrollable molten pool shape caused by gravity of a liquid molten pool and easy generation of a lack-of-fusion defect, lowering a voltage by 0.5 V to 2 V to reduce an arc length or reducing inductance by 0.5 H to 1 H to increase arc stiffness in an overhead welding position, thereby improving directivity and stability of an arc, and meanwhile increasing an arc swing width by 0.2 mm to 0.6 mm in the overhead welding position to eliminate the lack-of-fusion defect.

2. The welding method for improving the quality of 5G all-position welding of the marine riser according to claim 1, wherein the overhead welding position is where an overhead welding angle is 120° to 180°.

3. The welding method for improving the quality of 5G all-position welding of the marine riser according to claim 1, wherein a robot or a rail car is adopted to achieve fully automatic welding.

4. The welding method for improving the quality of 5G all-position welding of the marine riser according to claim 1, wherein a size of the marine riser ranges from 6 inches to 18 inches.

5. The welding method for improving the quality of 5G all-position welding of the marine riser according to claim 1, wherein a wall thickness of the marine riser is 19 mm to 32 mm.

6. The welding method for improving the quality of 5G all-position welding of the marine riser according to claim 1, wherein a groove form of the marine riser is U-shaped.

7. A marine riser prepared by the method according to claim 1.

8. A marine riser prepared by the method according to claim 2.

9. A marine riser prepared by the method according to claim 3.

10. A marine riser prepared by the method according to claim 4.

11. A marine riser prepared by the method according to claim 5.

12. A marine riser prepared by the method according to claim 6.
